(19) United States
(12) Patent Application Publication
(10) Pub. No.: US 2016/0165305 A1
(43) Pub. Date: Jun. 9, 2016

(54) ELECTRONIC DEVICE AND CONTROL METHOD

(71) Applicant: KABUSHIKI KAISHA TOSHIBA, Tokyo (JP)

(72) Inventors: Takashi DOI, Tokyo (JP); Hideki MIYASATO, Yokohama (JP)

(73) Assignee: KABUSHIKI KAISHA TOSHIBA, Tokyo (JP)

(21) Appl. No.: 15/046,019

(22) Filed: Feb. 17, 2016

Related U.S. Application Data
(63) Continuation of application No. PCT/JP2013/085171, filed on Dec. 27, 2013.

(51) Int. Cl. H04N 21/4363; H04N 21/439; H04N 21/637; H04N 21/426

(52) U.S. Cl. CPC H04N 21/43635; H04N 21/42646; H04N 21/439; H04N 21/637; H04N 21/4263

(57) ABSTRACT

According to one embodiment, an electronic device includes a transceiver circuit and one or more hardware processors. The one or more hardware processors are coupled to the transceiver circuit. The one or more hardware processors are configured to broadcast, to a network, a setting command by using the transceiver circuit. The setting command specifies dentification information on a first audio device selected from a plurality of audio devices connected via the network and activates an audio control function of the first audio device. The one or more hardware processors are configured to transmit an audio control command to the first audio device by using the transceiver circuit if the audio control function of the first audio device is activated by the setting command.

### CROSS-REFERENCE TO RELATED APPLICATIONS

This application is a continuation of International Application No. PCT/JP2013/085171, filed on Dec. 27, 2013, the entire contents of which are incorporated herein by reference. reference.

### FIELD

Embodiments described herein relate generally to an electronic device and a control method.

### BACKGROUND

The high-definition multimedia interface (HDMI) (registered trademark) 1.4b standard that is a standard used in connecting devices to transfer video contents can configure network topologies with a television being the center of the devices. The HDMI 1.4b standard connects devices to allow a user to control, for example, a video reproduction device such as a digital versatile disc (DVD) recorder and an audio reproduction device such as an audio visual (AV) amplifier by operating a remote remote control of the television. In particular, the user can perform audio reproduction control such as specifying an output destination device and controlling reproduction volume without considering which device to control between the television and the audio reproduction device.

Although the current HDMI 1.4b standard can connect a plurality of audio reproduction devices, the user can only control one audio reproduction device such as an AV amplifier fixed by a logical address to the television. Thus, there is much room for improvement in terms of convenience to users and flexibility in configuring the devices.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating an example of a configuration of an audio reproduction system according to a first embodiment;

FIG. 2 is an exemplary block diagram illustrating an example of a configuration of a television in the first embodiment;

FIG. 3 is an exemplary block diagram illustrating an example of functional configurations of a controller in the first embodiment;

FIG. 4 is an exemplary sequence diagram illustrating an example of audio control processing in the first embodiment;

FIG. 5 is an exemplary flowchart illustrating an example of the audio control processing in the first embodiment;

FIG. 6 is an exemplary diagram illustrating an example of an active audio renderer selection screen in the first embodiment;

FIG. 7 is an exemplary sequence diagram illustrating an example of audio control processing according to a second embodiment;

FIG. 8 is an exemplary flowchart illustrating an example of the audio control processing in the second embodiment; and

FIG. 9 is an exemplary diagram illustrating an example of an active audio renderer setting screen in the second embodiment.

### DETAILED DESCRIPTION

In general, according to one embodiment, an electronic device comprise a transceiver circuit and one or more hardware processors. The one or more hardware processors are coupled to the transceiver circuit. The one or more hardware processors are configured to broadcast, to a network, a setting command by using the transceiver circuit. The setting command specifies identification information on a first audio device selected from a plurality of audio devices connected via the network and activates an audio control function of the first audio device. The one or more hardware processors are configured to transmit an audio control command to the first audio device by using the transceiver circuit if the audio control function of the first audio device is activated by the setting command.

The following describes embodiments in detail with reference to the accompanying drawings.

### First Embodiment

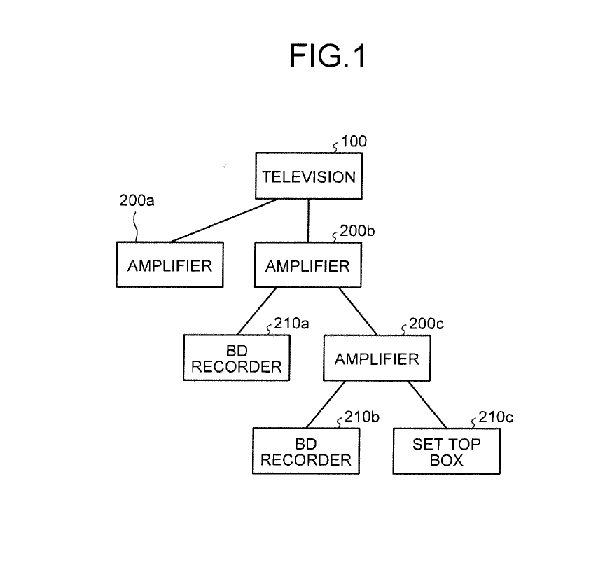

As illustrated in FIG. 1, an audio reproduction system according to a first embodiment is configured to comprise a television 100, three AV amplifiers (hereinafter “amplifier”) 200a, 200b, and 200c, two Blu-ray (registered trademark) disc (BD) recorders 210a and 210b, and a set top box 210c. These devices are connected via HDMI 1.4b-compliant interfaces (hereinafter “HDMI interface”).

Specifically, as illustrated in FIG. 1, the television 100 is connected with the amplifiers 200a and 200b via HDMI cables. The amplifier 200b is connected with the BD recorder 210a and the amplifier 200c via HDMI cables. The amplifier 200c is connected with the BD recorder 210b and the set top box 210c via HDMI cables. In other words, the amplifier 200c, the BD recorders 210a and 210b, and the set top box 210c are connected with the television 100 in a network structure of a hybrid topology including the daisy chain wiring scheme and the star topology.

In the context of the first embodiment, devices connected via HDMI interfaces as illustrated in FIG. 1 are referred to as devices in a network, or devices on a network.

The amplifiers 200a, 200b, and 200c are audio reproduction devices that amplify an audio signal and output the signal to, for example, a speaker. The three amplifiers 200a, 200b, and 200c may be hereinafter collectively referred to as amplifiers 200. The audio reproduction devices are devices that can reproduce sound.

The BD recorders 210a and 210b are devices that can record and reproduce data on a BD and a DVD. The set top box 210c is a device that receives a broadcast signal such as a cable television broadcast signal and converts the signal into a signal that can be viewed on an ordinary television.

The television 100 is an HDMI sink device, and the other devices (amplifiers 200, BD recorders 210a and 210b, set top box 210c ) are HDMI source devices.

In the context of the first embodiment, the devices (television 100, amplifiers 200a, 200b, and 200c, BD recorders 210a and 210b, set top box 210c ) illustrated in FIG. 1 each support the audio return channel function. This function eliminates optical cables for transmitting audio signals between the television 100 and the other devices, and the television 100 and the other devices can transmit and receive video and audio signals only by the HDMI cables.

The number of the amplifiers 200, the BD recorders 210a and 210b, and the set top box 210c connected to the television 100 in FIG. 1 is given for illustrative purposes only, and the number of the devices is not limited to this. The devices connected to the television 100 are given for illustrative purposes only, and the devices are not limited to the amplifiers 200, the BD recorders 210a and 210b, or the set top box 210c. The structure of the network (network topology) illustrated in FIG. 1 is also given for illustrative purposes only, and various network structures can be implemented.

When a plurality of devices are connected to the television 100 via HDMI interfaces, the television 100 allocates logical addresses (LAs) to the television 100 itself and the respective devices on the network.

The logical addresses each indicate the type of functions of the devices connected via HDMI interfaces. The HDMI 1.4b standard defines that the logical address of a television is 0, that of a tuner is 3, that of a video reproduction device is 4, and that of an audio reproduction device is 5.

The HDMI 1.4b standard only allows a user to perform audio reproduction control (consumer electronics control [CEC] cooperation) on one audio reproduction device to which the logical address 5 is allocated. The logical address 5 cannot be flexibly allocated to a desired device. Thus, in FIG. 1, for example, the logical address 5 is allocated to either one of the amplifiers 200a and 200b under the HDMI 1.4h standard, and the device that can perform audio interaction with the sink device (the television 100 in the first embodiment) is limited to this amplifier in the network. In other words, although the television 100 transmits an audio control command to the network as necessary, the control command is always transmitted to the device with the logical address 5. The device with the logical address 5 controls audio to be output from the speaker of the device or from an external speaker connected to the device in accordance with the received audio control command.

When a plurality of audio reproduction devices such as the amplifiers 200a, 200b, and 200c are connected as illustrated in FIG. 1, it is desirable for the user to select any amplifier 200, not limited to the amplifier with the logical address 5, and reproduce audio. This configuration will improve convenience to the user. The first embodiment, in which a plurality cf audio reproduction devices are connected via HDMI interfaces, implements the following configuration to enable the user to perform audio reproduction control (CEC cooperation) on any amplifier 200 other than the device with the logical address 5. CEC is an HDMI-compliant standard with regard to control information.

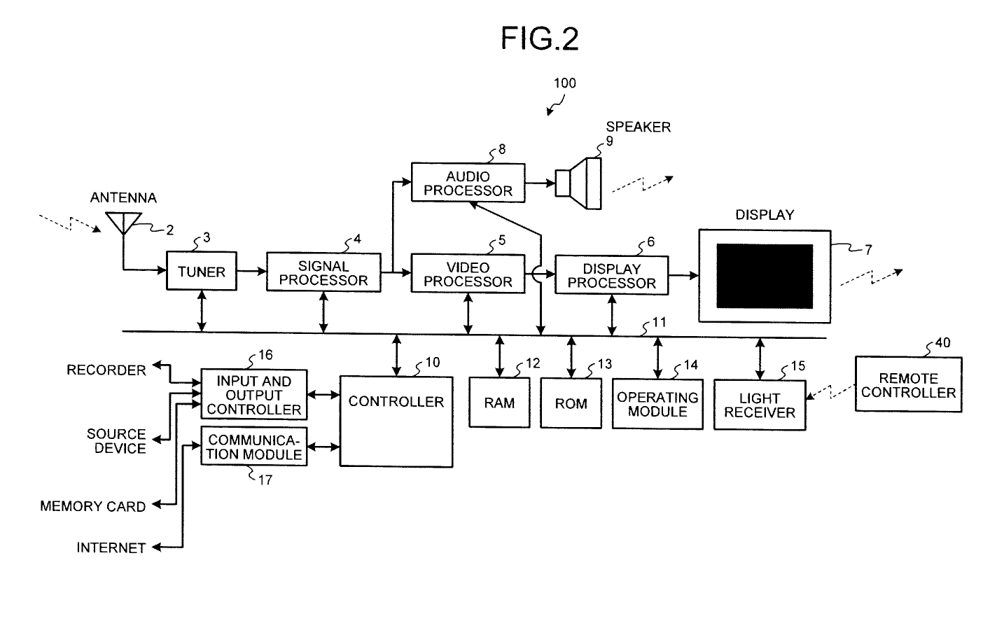

Details of the television 100 according to the first embodiment will be described. As illustrated in FIG. 2, the television 100 in the first embodiment mainly comprises an antenna 2, a tuner 3 for receiving digital broadcasting, a signal processor 4, a video processor 5, a display processor 6, a display 7, an audio processor 8, a speaker 9, a controller 10, a communication line 11, a random access memory (RAM) 12, a read only memory (ROM) 13, an operating module 14, a light receiver 15, an input and output controller 16, and a communication module 17.

The antenna 2 receives digital broadcasting of, for example, broadcasting satellites (BS), communication satellites (CS) and ground waves. The tuner 3 selects a channel specified by a user to be viewed. The signal processor 4 extracts and processes, under the control of the controller 10, signals demodulated by the tuner 3 and signals input from the input and output controller 16 as various digital signals. The signal processor 4 separates the input signals into a video signal and an audio signal, and outputs the video signal to the video processor 5, and the audio signal to the audio processor 8.

The video processor 5 performs processing for adjusting the video signal input from the signal processor 4 to a suitable screen size, and also performs image processing such as noise reduction processing on the video signal to improve video image quality.

The display processor 6 displays the video signal output from the video processor 5 on the display 7. The display processor 6 superimposes on-screen display (OSD) such as text information on the video signal output from the video processor 5. The display 7 displays the video signal on a screen. The user watches the screen on the display 7 to view a television image.

The audio processor 8 performs audio processing on the audio signal and amplifies it. The speaker 9 outputs the audio signal as sound. The user listens to the sound from the speaker 9 to listen to the television sound.

The controller 10 controls the modules of the television 100. The controller 10 is a processing module that can perform sequence processing. The controller 10 loads a computer program stored in the ROM 13 on the RAM 12 to execute it sequentially, and outputs control signals to the modules of the television 100 to centrally control the operations of the television 100.

The communication line 11 connects the tuner 3, the signal processor 4, the video processor 5, the display processor 6, the audio processor 8, and the controller 10 with one another and transfers data between the controller 10 and the tuner 3, the signal processor 4, the video processor 5, the display processor 6, or the audio processor 8. Specifically, the communication line 11 may be an inter-integrated circuit (IIC) bus. The RAM 12 and the ROM 13 store therein various kinds of data, and transfer and receive the data to and from the controller 10.

The operating module 14 is a switch that receives operation instructions from the user. The light receiver 15 receives a signal transmitted from a remote controller 40 that has received an operation instruction from the user. The user can operate the television 100 and the devices connected to the television 100 by operating various buttons and keys on the remote controller 40.

The communication module 17 has a communication function with a server connected via a network such as the Internet . The communication module 17 requests information from the server and receives the information transmitted from the server.

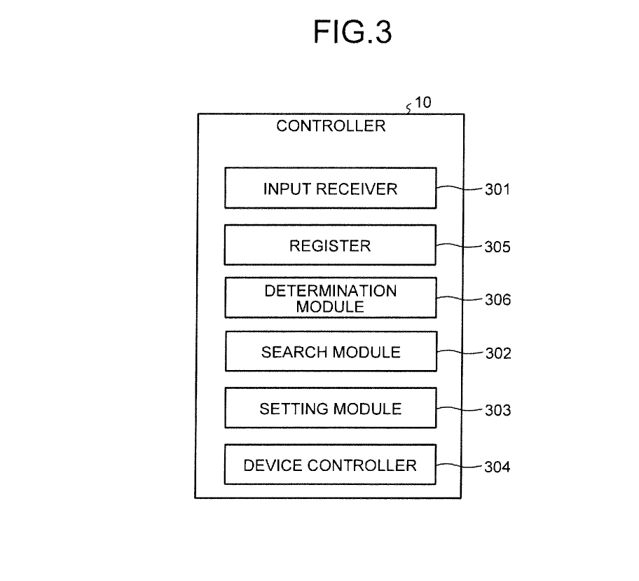

Described next are details of the functions performed by the controller 10. As illustrated in FIG. 3, the television 100 mainly comprises an input receiver 301, a register 305, a determination module 306, a search module 302, a setting module 303, and a device controller 304 as functional configurations implemented by the controller 10.

The input receiver 301 receives, from the user, selection of a desired device the audio reproduction control function (CEO cooperation function) of which will be activated to be a target of audio control. Hereinafter, the audio reproduction device the audio reproduction control function of which is activated and on which audio reproduction control is performed is referred to as an active audio renderer. When, for example, a sink device (television 100) transmits an audio control command to the physical address of an active audio renderer device, the device to which the physical address is allocated receives the audio control command and controls audio output from the speaker of the device or from an external speaker connected to the device in accordance with the audio control command.

The search module 302 broadcasts a search command by way of a broadcast message to the devices in the network. The search command is a command for searching the devices on the network for the active audio renderer and acquiring a physical address of the active audio renderer that has been found. The search command is compliant with CEC. For example, the search command is represented as follows, but the embodiment is not limited to this.

GetActiveAudioRenderer ( )

When a device the audio reproduction control function of which is activated as an active audio renderer receives the search command, the device transmits its physical address to the transmission source of the search command by way of a response message. When a device the audio reproduction control function of which is not activated as not an active audio renderer receives the search command, the device does not transmit any response message. The search module 302 receives a response message in response to the search command that has been broadcast.

The setting module 303 specifies the device selected by the user with a parameter and generates a setting command. The setting command is a command for setting the device specified by the parameter to be the active audio renderer, in other words, a command for activating the audio reproduction control function of the device. The setting command is compliant with CEC. For example, the setting command is represented as follows, but the embodiment is not limited to this.

SetActiveAudioRenderer (Paral)

The “paral” represents a parameter of the setting command by which the physical address of the device to be set as the active audio renderer is specified. When a device other than the device that transmits the setting command is set as the active audio renderer, the physical address of the device is specified in the parameter “paral”.

The setting module 303 broadcasts the generated setting command by way of a broadcast message to the devices in the network. The physical address is an example of identification information.

When the device that transmits the setting command sets itself to be the active audio renderer, the physical address of the device is specified in the parameter “paral”. In this case, the device set as the active audio renderer broadcasts the setting command, so that the other devices in the network can be informed that the device is the active audio renderer.

When the device having the physical address specified by the setting command successfully activates its audio reproduction control function, in other words, successfully sets itself as the active audio renderer, the device transmits a response message indicating that the device has successfully activated the function to the transmission source of the setting command. The devices other than the device having the physical address specified by the setting command ignore the received setting command and transmit no response message.

The determination module 306 refers to, for example, the RAM 12 and determines whether the device selected by the user through the input receiver 301 is already registered as the active audio renderer.

The determination module 306 also determines whether the physical address contained in the response message received by the search module 302 in response to the search command is identical to the physical address of the device selected by the user, in other words, determines whether the response message is transmitted from the device selected by the user. The determination module 306 also determines whether the response message in response to the setting command indicates success.

When the determination module 306 determines that the response message in response to the search command is not from the device selected by the user, the setting module 303 broadcasts the setting command.

The register 305 stores the physical address of the device set as the active audio renderer in a storage medium such as the RAM 12 to register the device as the active audio renderer that is the target of audio control. Specifically, when the determination module 306 determines that the response message indicating success is received in response to the setting command, the register 305 registers the physical address of the audio reproduction device specified by the setting command as the active audio renderer that is the target of audio control.

When the response message in response to the search command is from the device selected by the user, the register 305 registers the physical address of the device selected by the user as the active audio renderer that is the target of audio control.

The device controller 304 transmits an audio control command that instructs, for example, volume control or mute to the device (that is, the active audio renderer device) having the physical address registered as the target device of audio control in, for example, the RAM 12.

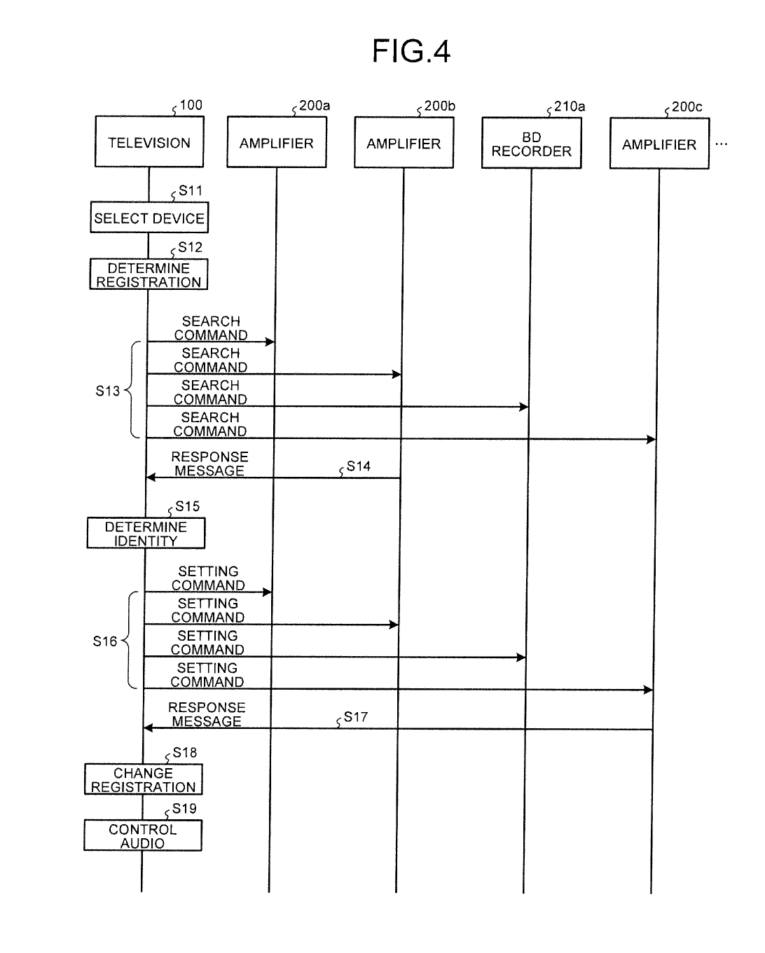

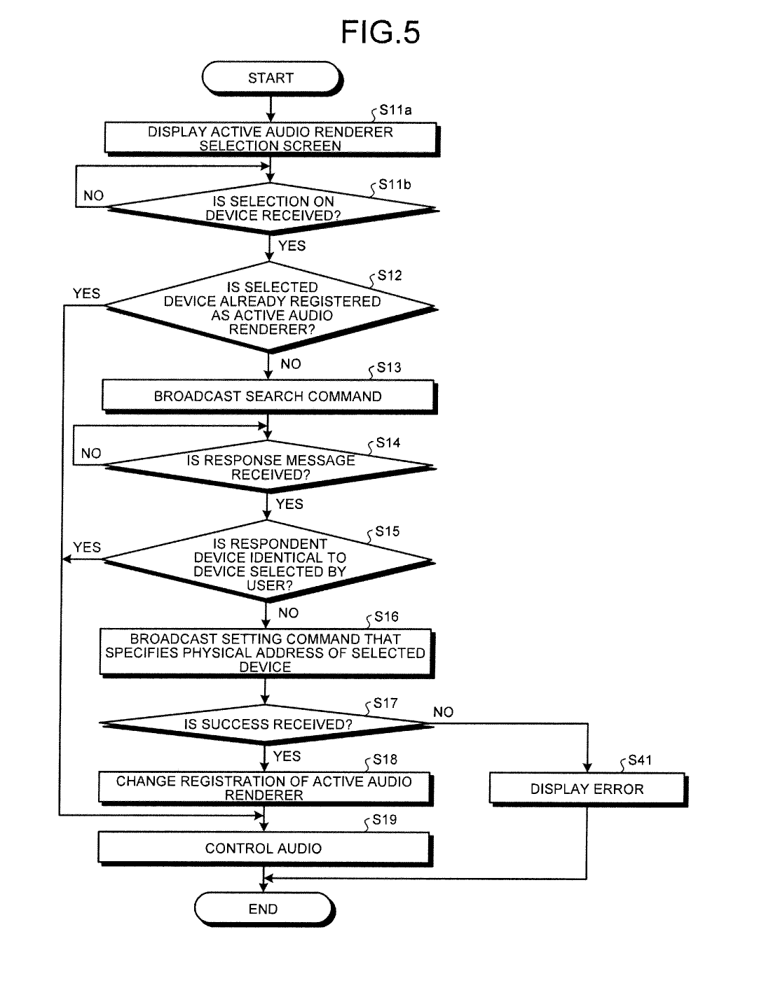

Described next is audio control processing performed by the television 100 according to the first embodiment configured as described above with reference to FIGS. 4 and 5.

It is premised that the television 100 polls the devices in the network connected via HDMI interfaces at regular intervals and has acquired all the physical addresses of the devices. It is premised that the logical addresses are already allocated to the devices in the network.

The television 100 selects a device to be set as the active audio renderer (S11). Specifically, the video processor 5 and the display processor 6 of the television 100 display an active audio renderer selection screen on the display 7 as an OSD (S11a). The input receiver 301 of the controller 10 waits for selection of a desired device to be set as the active audio renderer (No at S11b).

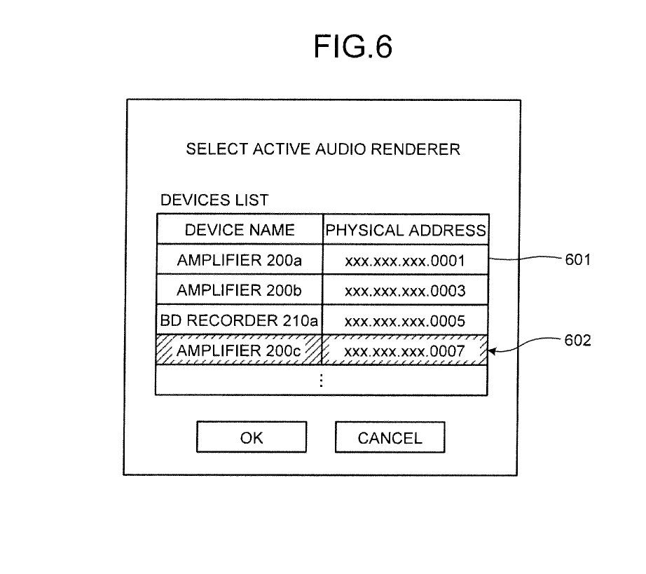

FIG. 6 illustrates an example of the active audio renderer selection screen according to the first embodiment. As illustrated in FIG. 6, a devices list 601 including device names and physical addresses of the devices in the network is displayed on the active audio renderer selection screen.

The user selects a desired device to be set as the active audio renderer from the devices displayed in the devices list 601 with, for example, the remote controller 40 or the operating module 14. The reference sign 602 in FIG. 6 indicates a selected state of a device. When the user selects a device, the input receiver 301 of the controller 10 receives the selection of the device (Yes at S11b).

After a device is selected, the television 100 determines whether the selected device is registered (S12). Specifically, the determination module 306 refers to, for example, the RAM 12 and determines whether the selected device has already been registered as the active audio renderer that is the target of audio control.

If the selected device has already been registered as the active audio renderer that is the target of audio control (Yes at S12), the device controller 304 transmits an audio control command to the device registered as the active audio renderer and performs audio reproduction control on the device (S19).

If yes at S12, the television 100 may display an identifier (device name, for example) of the device registered as the active audio renderer together with information indicating that the device is registered as the active audio renderer. In this case, the display processor 6 of the television 100 displays, for example, a message “amplifier 200c is registered as active audio renderer” on the display 7.

If the selected device is not registered as the active audio renderer that is the target of audio control (No at S12), the search module 302 generates the above-described search command and broadcasts the generated search command to the devices in the network (S13). The television 100 then waits for a response message from a device set as the active audio renderer (No at S14).

When receiving a response message (Yes at S14), the television 100 determines whether the device that has transmitted the response message is identical to the device selected by the user to be set as the active audio renderer (S15).

Specifically, the determination module 306 acquires the physical address of the device that has transmitted the response message, that is, of the device set as the active audio renderer, from the response message. The determination module 306 then determines whether the acquired physical address of the device is identical to the physical address of the device selected by the user at S11 and S11a.

If both physical addresses are identical (Yes at S15), which means that the device selected by the user is already set as the active audio renderer, the device controller 304 transmits an audio control command to the device registered as the active audio renderer and performs audio reproduction control on the device (S19).

If yes at S15, the television 100 may display an identifier (device name, for example) of the device registered as the active audio renderer together with information indicating that the device is registered as the active audio renderer. In this case, the display processor 6 of the television 100 displays, for example, a message “amplifier 200c is registered as active audio renderer” on the display 7.

In FIG. 5, for example, it is premised that the user has selected the amplifier 200c as the device to be set as the active audio renderer, but that the amplifier 200c has not been registered as the active audio renderer in the television 100. It is also premised that the amplifier 200b is already set as the active audio renderer and is registered as the active audio renderer in the television 100. With this premise, the amplifier 200b transmits a response message in response to the search command to the television 100 according to S14. Such premise is presented for illustrative purposes only, and the embodiment is not limited to this.

At S15, if both physical addresses are not identical, in other words, the device that has transmitted the response message differs from the device selected by the user (No at S15), the processing shifts to S16. In FIG. 5, for example, the device that has transmitted the response message is the amplifier 200b and the device selected by the user is the amplifier 200c. Thus, the determination module 306 determines that both are not identical.

At S16, the setting module 303 specifies the device selected by the user and generates a setting command, and then broadcasts the generated setting command to the devices in the network (S16).

In FIG. 5, for example, the physical address of the amplifier 200c is specified in the setting command. Accordingly, the amplifier 200c activates its audio reproduction control function upon receiving the setting command and transmits a response message indicating success to the television 100 (S17).

If the television 100 receives the response message indicating success (Yes at S17), the register 305 changes the active audio renderer registered in, for example, the RAM 12 to the device selected by the user (S18). The device controller 304 performs audio control on the device newly registered as the active audio renderer (S19).

At S18, the television 100 may display an identifier (device name, for example) of the device newly registered as the active audio renderer together with information indicating that the device is newly registered as the active audio renderer. In this case, the display processor 6 of the television 100 displays, for example, a message “amplifier 200c is newly registered as active audio renderer” on the display 7.

At S17, if the television 100 does not receive a response message indicating success (No at S17), in other words, if the television 100 receives a response message indicating failure or receives no response message after a certain time has passed, the video processor 5 and the display processor 6 display an error message on the display 7 as an OSD (S41).

The first embodiment above, in which a plurality of audio reproduction devices are connected to the television 100 via HDMI interfaces, enables a user to select any device to set it as an active audio renderer on which the user can perform audio control irrelevant to the logical address. This configuration in the first embodiment can improve convenience to the user and flexibility in a configuration in which a plurality of devices are connected via HDMI interfaces.

In the first embodiment, the television 100 and the other devices support the audio return channel function, and can select any device to set it as an active audio renderer irrelevant to the logical address. Thus, it is possible to implement that audio is reproduced by any audio reproduction device only via an HDMI cable.

### Second Embodiment

In the first embodiment, a user selects a device to be set as an active audio renderer, and the television 100 broadcasts a setting command to set the selected device to be the active audio renderer.

As described above, when a device that is a transmission source of a setting command sets itself to be the active audio renderer, the device can specify its own physical address in the parameter “paral” and broadcast the setting command.

In a second embodiment, a device sets itself to be the active audio renderer and broadcasts a setting command to the television 100 and the other devices in the network to let them be informed that the device is the active audio renderer.

The network configuration of the audio reproduction system, the configuration of the television 100, and the functional configurations of the controller 10 in the second embodiment are the same as those in the first embodiment.

When the register 305 according to the second embodiment receives, from a device on the network, a setting command in which the physical address of the device is specified, the register 305 registers the physical address specified in the received setting command in, for example, the RAM 12 as the active audio renderer that is the target of audio control.

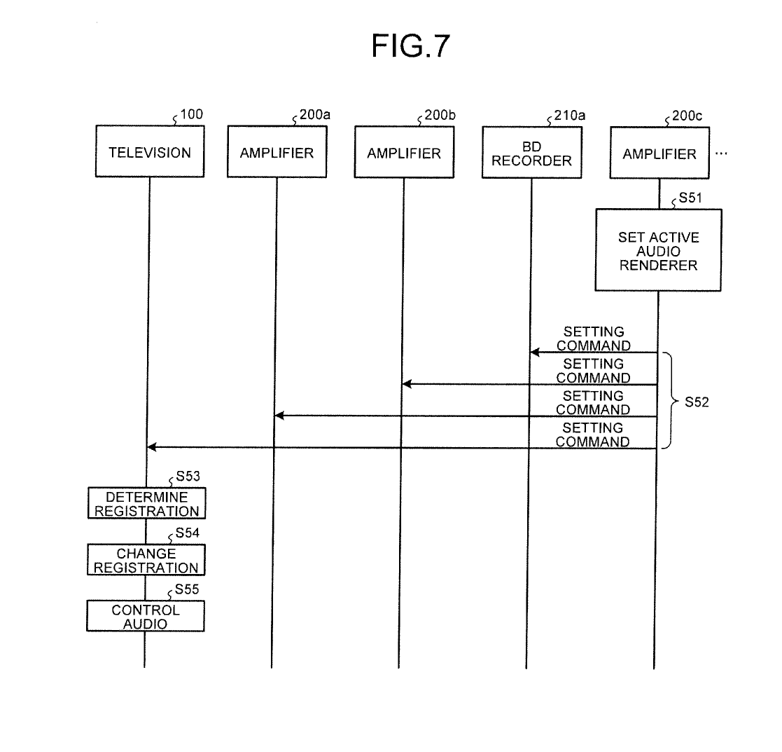

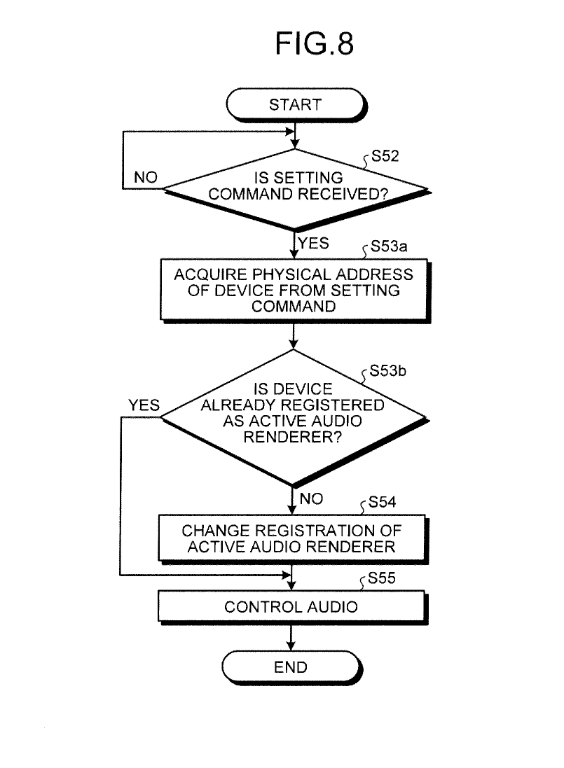

Described next is audio control processing performed by the television 100 according to the second embodiment configured as described above with reference to FIGS. 7 and 8. In FIG. 7, for example, the amplifier 200c sets itself to be the active audio renderer.

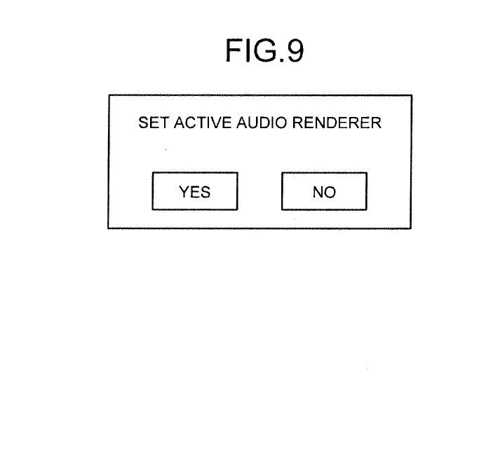

The amplifier 200c sets itself to be the active audio renderer upon receiving an instruction from a user (S51). Specifically, the user can operate, for example, a certain switch on the amplifier 200c to set the amplifier 200c as the active audio renderer. Alternatively, for example, a display of the amplifier 200c displays an active audio renderer setting screen illustrated in FIG. 9 and the user clicks a yes button on it, and the amplifier 200c can be set as the active audio renderer.

After completing the setting of the active audio renderer, the amplifier 200c broadcasts a setting command in which its physical address is specified, to the devices (including the television 100) in the network (S52).

When receiving the setting command from the amplifier 200c (Yes at S52), the television 100 determines whether the device is registered as the active audio renderer (S53).

Specifically, the determination module 306 acquires, from the setting command, the physical address of the amplifier 200c that is the transmission source of the setting command (S53a). The determination module 306 refers to, for example, the RAM 12, and determines whether the acquired physical address of the device has already been registered as the active audio renderer that is the target of audio control (S53b).

If the acquired physical address of the device has already been registered as the active audio renderer that is the target of audio control (Yes at S53b), the device controller 304 transmits an audio control command to the device registered as the active audio renderer, and performs audio reproduction control on the device (S55).

If the acquired physical address of the device is not registered as not the active audio renderer that is the target of audio control (No at S53b), the register 305 changes the active audio renderer registered in, for example, the RAM 12 to the device (amplifier 200c ) having the physical address acquired from the setting command (S54). The device controller 304 transmits an audio control command to the device newly registered as the active audio renderer, and performs audio reproduction control on the device (S55).

In the second embodiment above, a device in a network sets itself to be the active audio renderer and broadcasts a setting command to the television 100 and the other devices in the network to let them be informed that the device is the active audio renderer. This configuration in the second embodiment can further improve convenience to the user and flexibility in a configuration in which a plurality of devices are connected via HDMI interfaces.

Although, in the context of the first and the second embodiments above, the audio reproduction devices are the amplifiers 200, the audio reproduction devices are not limited to the amplifiers 200 and may be any devices that can reproduce audio.

Although, in the context of the first and the second embodiments above, the search command and the setting command are compliant with CEO, the embodiments are not limited to this. The search command and the setting command may be configured to be provided in a form of, for example, extended display identification data (EDID) or InfoFrame.

Although, in the context of the first and the second embodiments above, the television 100 and the other devices are connected via HDMI interfaces, they may be connected via interfaces compliant with the mobile high-definition link (MHL) standards. In this case, the search command and the setting command can be configured in a form compliant with a remote control protocol (RCP).

An audio control program executed by the television 100 according to the embodiments above is installed in advance in, for example, the ROM 13 to be provided as a computer program product.

The audio control program executed by the television 100 according to the embodiments above may be recorded and provided in a computer-readable recording medium such as a compact disc read only memory (CD-ROM), a flexible disk (FD), a compact disc recordable (CD-R), and a digital versatile disc (DVD), as an installable or executable file, and may be provided as a computer program product.

The audio control program executed by the television 100 according to the embodiments above may be stored in a computer connected to a network such as the Internet and provided, as a computer program product, by being downloaded via the network. Furthermore, the audio control program executed by the television 100 according to the embodiments above may be provided or distributed, as the computer program product, via a network such as the Internet.

The audio control program executed by the television 100 according to the embodiments above is configured by modules including the modules (the input receiver 301, the register 305, the determination module 306, the search module 302, the setting module 303, and the device controller 304) described above. As actual hardware in the embodiments above, the modules are loaded on the RAM 12 when a CPU reads out and executes the audio control program from the ROM 13, and the input receiver 301, the register 305, the determination module 306, the search module 302, the setting module 303, and the device controller 304 are generated on the RAM 12.

Moreover, the various modules of the system described herein can be implemented as software applications, hardware and/or software modules, or components on one or more computers such as a server. While the various modules are illustrated separately, they may share some or all of the same underlying logic or code.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a transceiver circuit; and
one or more hardware processors coupled to the transceiver circuit and configured to:
broadcast, to a network, a setting command by using the transceiver circuit, the setting command specifying identification information on a first audio device selected from a plurality of audio devices connected via the network and activating an audio control function of the first audio device; and
transmit an audio control command to the first audio device by using the transceiver circuit if the audio control function of the first audio device is activated by the setting command.

2. The electronic device of claim 1, wherein the one or more hardware processors are configured to:
broadcast, to the network, a search command by using the transceiver circuit; and
broadcast, to the network, the setting command when a response to the search command is not received from the first audio device.

3. The electronic device of claim 2, wherein the one or more hardware processors are configured to transmit the audio control command to the first audio device if a response to the search command is received from the first audio device.

4. The electronic device of claim 1, wherein the one or more hardware processors are configured to:
receive a second setting command from a second audio device, the second audio device being one of the audio devices, the second setting command specifying identification information on the second audio device and being transmitted if the audio control function of the second audio device is activated; and
register the second audio device as a target of audio control.

5. The electronic device of claim 1, further comprising:
a display configured to display information on the audio devices connected to the electronic device via the network, wherein
the one or more hardware processors are configured to receive an operation selecting the first audio device from the audio devices, the first audio device being a target of audio control.

6. The electronic device of claim 5, wherein the display displays information on the audio device registered as the target of audio control together with information indicating that the audio device is the target of audio control.

7. The electronic device of claim 5, further comprising:
a tuner configured to receive a broadcast wave, wherein
the display displays a video image of the broadcast wave received by the tuner.

8. The electronic device of claim 1, wherein the electronic device and the audio devices support an audio return channel function.

9. A control method comprising:
broadcasting, to a network, a setting command for activating an audio control function, the setting command specifying identification information on a first audio device selected from a plurality of audio devices connected via the network; and
transmitting an audio control command to the first audio device.
